(19) United States
(12) Patent Application Publication
(10) Pub. No.: US 2024/0381995 A1
(43) Pub. Date: Nov. 21, 2024

(54) BRUSH FOR A SONIC TOOTHBRUSH WITH LONGITUDINAL AXIS OSCILLATION

(71) Applicant: Curaden AG, Kriens (CH)

(72) Inventor: Marco ZAVALLONI, Wohlen AG (CH)

(21) Appl. No.: 18/691,786

(22) PCT Filed: Sep. 14, 2022
(86) PCT No.: PCT/EP2022/075567

§ 371 Date: Mar. 13, 2024

(30) Foreign Application Priority Data
Sep. 14, 2021 (EP) 21196658.5

(51) Int. Cl. A46D 1/00; A46B 5/00; A46B 9/04; A46B 9/06; A46B 13/02; A61C 17/20; A61C 17/32

(52) U.S. Cl. CPC A46D 1/0253; A46B 5/0095; A46B 9/04; A46B 9/06; A46B 13/02; A61C 17/20; A61C 17/32

(57) ABSTRACT

A brush includes an elongated base body having a base portion that provides an adapter for rotationally fixed coupling to a sonic toothbrush drive in order to pivotally oscillate the brush about a base portion longitudinal axis. A bristle support is formed on a head portion of the elongate base body, and bristles extend from the head portion at least substantially perpendicularly. A neck portion connects the base portion and the head portion. The elongated base body bends at a bend angle γ formed by the base portion longitudinal axis and a head portion orientation axis in the range of 7° to 17°. The bristle support has a deflection A in the range of 5% to 15% with reference to a length L of the base body. At least a portion of the bristles has a value σₓ in the range from 0.1 to 10 MPa.

### CROSS-REFERENCE

This application is the U.S. National Stage of International Application No. PCT/EP2022/075567 filed on Sep. 14, 2022, which claims priority to European patent application no. 21 196 658.5 filed on Sep. 14, 2021.

### TECHNICAL FIELD

The present invention generally relates to a brush for a sonic toothbrush with longitudinal axis oscillation and to a set comprising such a brush and a hand apparatus with a sonic brush drive.

### BACKGROUND ART

There are different types of electrically powered toothbrushes.

The principle of a round brush head, which can rotate around an axis parallel to the bristle direction and is moved back and forth around this axis, is known from the publications DE 10 2016 011477 (Schiffer), EP 2 454 967 A1 (Braun), WO 2005/046508 A1 (Trisa) and others. The advantage of this arrangement is that the moving part (namely the round brush head) is very small. It does not require much drive energy and the forces (torques) that occur tend to be small. The disadvantage of this principle is that the bristle movement depends on the distance to the axis of rotation. The closer the bristles are to the axis of the brush head, the smaller the back and forth movement. The movement pattern is therefore very inhomogeneously distributed across the bristle field.

The principle of pendulum motion is known from the publications JP H04-43127 (Kao), US 2006/168744 A1 (Butler), US 2012/0291212 (Montagnino) and others. In these publications, the brush oscillates about a pendulum axis which is perpendicular to the hand apparatus (drive) and to the attached brush and which intersects the longitudinal axis of extension of the hand apparatus and brush at the point where the brush is coupled to the hand apparatus. The advantage is that the intensity of movement is homogeneously distributed over the entire bristle field because all the bristles have, in particular, more or less the same distance from the pendulum axis. The disadvantage, however, is that relatively large forces (moments) occur because the mass of the brush head is relatively far away from the pendulum axis.

The principle of housing vibration is known from the publications JP 2012-161368 (Sanion), DE 299 13 406 U1 (Rowenta), U.S. Pat. No. 6,766,548 B1 (Rowenta), WO 2005/046508 A1 (Trisa), WO 2013/104020 A1 (Erskine) and others. A drive in the hand apparatus or in the brush neck generates an undefined vibration that is transmitted to the bristles. The advantage of this design is that one does not have to concern oneself with the technical details of motion transmission. The disadvantage, however, is that the entire housing has to be vibrated and accordingly, more drive energy is required than if only a small part has to be vibrated. In addition, the vibration must not be too strong, as this impairs comfort when holding the hand apparatus. Finally, the effective movements of the bristles are not known and the cleaning effect of this type of undefined and uncontrolled vibration is anything but optimal.

Another principle is known from the publications WO 2012-151259 A1 (Water Pik), EP 2 548 531 B1 (Trisa) and others. In these publications, the hand apparatus has a coupling pin that rotates back and forth around the longitudinal axis. The brush mounted on the coupling pin has a straight neck and a bristle plate at the end, from which the bristles are (extend) transverse to the longitudinal axis of the hand apparatus or the brush neck. The advantage of this geometry is that relatively low forces (moments) occur because the mass (neck, bristle plate) of the brush attachment is relatively close to the longitudinal axis (center of movement). The intensity of movement is also distributed relatively evenly across the bristle field.

However, the disadvantage of this principle is that the bristles only carry out (undergo) a one-dimensional movement (back and forth).

It is known that the cleaning effect of manual toothbrushes depends on the hardness of the bristles. Depending on the intended use, bristles of different hardness have different cleaning effects and different damage potential. These effects are known among experts and are regularly included in the advice given to patients.

WO 2016/178142 A1 (Braun GmbH), for example, discloses a manual toothbrush with spring-mounted bristles. The bristles protrude from a carrier plate at an oblique angle and are thereby particularly springy. This allows them to change their length under load, which increases comfort for the gums. The range for the buckling force of a bristle is specified as 0.01 N to 2 N, for example 0.4 N.

The importance of the softness or flexibility of the filaments has also been discussed for electrically powered toothbrushes.

EP 1 713 413 B1 (Church & Dwight), for example, describes a modular-constructed electric toothbrush in which the user can replace certain parts of the brush head. The brush head consists of a stationary bristle support and a bristle support that can be moved linearly in the longitudinal direction of the brush. The bristle stiffness is mentioned as a factor in the cleaning efficiency of this design. This is represented as a function of four parameters: bristle diameter, bristle length, Young's modulus, number of bristles of the brush. The bristle stiffness should be in the range of 0.2 to 0.8.

Sonic toothbrushes are very comfortable for the user and are also considered to be efficient because the electrically driven brush makes (undergoes) the movements much faster than can be done by hand.

In the case of sonic toothbrushes, it has previously been assumed that the higher the frequency of the motor and the greater the cleaning movement of the bristles, the better the cleaning results.

A sonic toothbrush, which has an angled brush head, is known from WO 2017/050612 A1 (Curaden). Because this sonic toothbrush is angled forwards, the various areas of the dentition are more easily accessible. In addition, the bend enables the filaments of the brushes to oscillate with a greater amplitude transverse to the longitudinal axis of the brush. The preferred operating frequency is 2000 to 8000 Hertz. However, the frequencies can also be higher, for example 10 kHz, 50 kHz or even higher, for example 200 Hz or 500 Hz.

An ultrasonic toothbrush is known from US 2012/0291212 A1, which has two parallel channels running transverse to the longitudinal axis of the brush to increase the resonant frequency. The frequency is increased in the forward-rearward direction if the two channels are positioned at the front. If the channels are provided on the left and right of the brush neck, the frequency is increased in the lateral direction.

There is still a lack of sufficient understanding of the cleaning behavior of sonic toothbrushes. The knowledge we have today about the cleaning effect of manual toothbrushes cannot be transferred to the highly dynamic situation of a sonic toothbrush. EP 1 713 413 (Church & Dwight) points out that a bristle stiffness of 0.2-0.8 is advantageous for the effectiveness of cleaning. EP 3 291 700 (Braun) describes a buckling force in the range of 0.01 N to 2 N as advantageous.

### SUMMARY

It is one non-limiting object of the present disclosure techniques for improving a toothbrush for sonic toothbrushes to provide a better cleaning effect, in particular one which is gentle on the gums. In particular, a defined and controlled two-dimensional movement of the bristles can be generated.

According to one aspect of the present disclosure, at least a portion (e.g., the essential part) of the bristles has a value σₖ in a range from 0.1 MPa to 10 MPa, wherein

$${σ}_{k} = \frac{{π}^{3}}{{L}^{2}} \cdot E \cdot {r}^{2}$$

π=number Pi(=3.14),
E=Young's modulus of the bristles,
r=half the diameter of the bristle, and
L=length of the bristle.

It was found that the desired two-dimensional movement of the bristle tips is a combination effect of the geometry of the brush according to the present disclosure and the above-specified value σₖ of the bristles. In particular, the two-dimensional movement can be described as a kind of “Figure 8” movement, because the bristle tips basically trace the shape of the number “8”. The shape of the “8” is thus considerably larger in a y-direction (width) than in the perpendicular x-direction (length or longitudinal direction). The exact geometry of the “Figure 8” movement can be controlled by various factors.

Another aspect of the present disclosure provides the following basic features:
a) The brush has a base portion on which an adapter for the hand apparatus, i.e. a so-called drive adapter, is formed. The adapter is geometrically designed to be connected to a coupling part (e.g. a pin) of the sonic toothbrush drive in a rotationally fixed (but replaceable) manner. The sonic tooth brush drive generates a longitudinal axis oscillation that is to be transmitted to the brush. The drive adapter defines a geometric base portion longitudinal axis (x) of the brush. This longitudinal axis is normally the direction in which the brush can be attached to the hand apparatus. The brush is rotated (pivoted, oscillated) back and forth around this longitudinal axis.
b) Furthermore, the brush has a head portion with a bristle support in which a plurality of bristles is anchored (bristle field). The head portion is in principle the upper end of the brush (whereas the base portion forms the lower end). The head portion defines a head portion orientation axis. The bristles anchored in the head portion, for example, protrude transversely to the head portion orientation axis. Typically, but not necessarily, the bristles are perpendicular to the head portion orientation axis.
c) The base body has a neck portion between the base portion and the head portion. The neck portion therefore connects the base portion and head portion. The design of the neck portion can be different.

In a particular embodiment, the neck portion is tapered (narrowed) in cross-section compared to the base portion. This means that, when the base portion is viewed in cross-section (with reference to the base portion longitudinal axis), the dimensions in the x or y direction are smaller than the cross-section of the neck portion (i.e. transverse to the neck portion longitudinal axis). Here, the tapered cross-section refers to the cross-sectional area. It is therefore not mandatory that the dimensions in the x-direction and y-direction are smaller.

In order for the bristle tips to make the “Figure 8” movement, the base body of the brush must be designed appropriately. The bend angle γ and the deflection play a role here. The bend angle γ ensures that the bristles, when they are perpendicular to the head portion orientation axis, are not perpendicular to the base portion longitudinal axis and therefore are not perpendicular to the axis of longitudinal axis oscillation. Instead, they form an angle in the range of 83° to 73°(=90°−7° and =90°−17°, respectively). The bend angle must be of a certain size so that the “Figure 8” movement can occur to a sufficient extent. If the bend angle is too large, the “Figure 8” movement collapses again or is degenerated by unwanted dynamic influences.

The deflection of the brush head also plays a role in the development (implementation) of the “Figure 8” movement. In the present context, the deflection is in the range of 5% to 20%. If the deflection is below this range, the movement of the head portion is not able to give sufficient excitation to the anchored part of the bristles. If the deflection is too great, oscillations can occur in the base body in combination with the bend angle, which operates counter to the excitation of the “Figure 8” movement according to the present disclosure.

According to a particular embodiment, the value σₖ is at most 4 MPa, e.g., at most 1 MPa. That is, the value σₖ is one of the parameters that has a particular influence on the shape of the “Figure 8” movement. If the value σₖ is significantly below the above-noted upper limit, the x-component of the “Figure 8” movement can become significantly larger. At a value σₖ of 1 MPa or less, the bristles are relatively flexible and can still perform (undergo) the “Figure 8” movement well even for brushes having a small bend angle and/or a small deflection.

According to another particular embodiment of the invention, the value σₖ is at least 1 MPa. It can thereby be achieved that the “Figure 8” movement in the x-direction is smaller. Another effect that can be achieved with this lower limit is that the deflection can be increased without the “Figure 8” movement becoming unstable. If the deflection is relatively large, this can lead to the bristle tips no longer carrying out (undergoing) a controlled “Figure 8” movement, but instead only “whip chaotically”.

In one particular embodiment, the value σₖ is in the range from 1 MPa to 4 MPa. This has the advantage that the brush is suitable for higher operating frequencies of 250 Hz and more in particular. Different operating frequencies can usually be set for sonic toothbrushes. The operating frequency is one of the parameters that has an influence on the movement of the bristle tips and therefore on the “Figure 8” movement. It is therefore important to ensure that the brush carries out (undergoes) an optimized “Figure 8” movement when the operating frequency recommended or preferred in the individual case matches the brush and the value σₖ of the bristles.

According to another particular embodiment, the Young's modulus of the material of the bristles is in the range of 1000 MPa to 3500 MPa. This makes it possible to work with materials such as polybutylene terephthalate (PBT) having 10% glass fibers. For materials having a Young's modulus in this range, the bristle length can be shorter without significantly reducing the value σₖ.

In particular, it can be advantageous for the Young's modulus not to exceed 2000 MPa. Such materials are also found in PBTs having a low glass fiber content.

However, it can also be advantageous to use materials having a Young's modulus in the range of 2500 MPa to 3500 MPa. This allows the bristle diameter to be reduced, which makes finer bristle tips possible.

The present disclosure also extends to particular embodiments which have a Young's modulus of 4000 MPa or more. This range can have advantages if the bristles are not in tightly packed tufts or if the mutual friction between the bristles is rather low. Another advantage can be that the bristles can be longer without losing the “Figure 8” movement. Such bristles can be produced, e.g., using polybutylene terephthalate (PBT) that contains carbon black.

According to a particular embodiment, the average length of the bristles is in the range of no more than 10 mm. If the bristles are too long, the brush can become unwieldy.

According to another particular embodiment, the average length of the bristles is at least 5 mm. This ensures that the cross-section of the bristles is fine, which is advantageous when producing the brush.

Typically, the bristles of the brush are grouped together in tufts. If the bristles in the tuft have different lengths (e.g. if the tuft is rounded or pointed at the end), then the average value of the bristle length in the tuft is used as the relevant bristle length in the context of the invention. If a brush has tufts of different lengths, then the different tufts generally also have a different function. The value σₖ may be particularly relevant for bristles or tufts that clean the edge area of the tooth or that are effective at the transition to the gum.

According to a particular embodiment, the deflection is in the range from 5% to 15%, e.g., in the range from 7% to 13%. The deflection is one of the factors influencing the geometric shape of the “Figure 8” movement. A large deflection tends to increase (amplify, enlarge) the “Figure 8” movement and a small deflection reduces it. However, the bend angle must also be taken into account. Because the “Figure 8” movement is based on a dynamic effect resulting from the combination of the various parameters (geometry of the brush, dimensioning, Young's modulus of the bristles, etc.) during operation, it also depends on the oscillation frequency at which the brush is operated. In particular embodiments of the present disclosure, the brushes are designed so that brushes exhibit (undergo) the “Figure 8 movement” when the sonic brush drive is operated at a frequency in the range from 100 Hz to 400 Hz, i.e. when such brushes are combined with a sonic brush drive operating in this frequency range.

Preferably, the deflection is in the range of 5 to 10 mm.

A further particular embodiment is that the bristles have a diameter of no more than 0.12 mm, e.g., no more than 0.1 mm. If a certain desired number of bristles per tuft is assumed in individual cases, a thinner tuft can be created with thinner bristles. The area of thinner bristles can be combined with an area of shorter bristle length.

Normally, the bristles are round in cross-section. If they have a non-circular cross-section, an average value between the maximum and minimum transverse dimension is considered to be the diameter within the meaning of the present disclosure.

According to other particular embodiments, the bend angle γ is in the upper range, e.g., in the range from 12° to 17°. This is advantageous for brushes in which the distance of the geometric bend position from the adapter plane is at least 50% of the length of the brush. (The geometric bend position results from the intersection of the base portion longitudinal axis and the head portion orientation axis.) This angle γ range can also be advantageous for brushes having only a single tuft of bristles.

Large bend angles seem to amplify the “Figure 8” movement of the bristle tips in the x-direction. This means that the eyes (loops) of the “Figure 8” movement become quasi larger.

In other particular embodiments, the bend angle y is in the range of 7° to 12°. This is advantageous for brushes in which the brush head is plate-shaped and has a plurality of bristle tufts. In addition, in these embodiments, the neck part can be tapered (narrowed) in cross-section relative to the head part.

According to a preferred embodiment, the bristles of the brush are arranged in the form of a plurality of tufts which are spaced apart from each other. The tufts can, for example, be arranged in such a way that an inner bristle field and an outer bristle field are defined. The inner bristle field is surrounded by the outer bristle field. The bristles in the inner bristle field can have a different length than the bristles in the outer bristle field. Within the scope of the invention, it is possible that only the bristles in the outer bristle field have the above-defined value σₖ.

However, it also generally corresponds to a particular embodiment in which at least two different bristle lengths are provided on the brush head. However, it is advantageous if bristles of different lengths belong to different bristle tufts. In other words, the bristle lengths within a single (each) bristle tuft are preferably in essence the same size.

According to a preferred embodiment, the adapter for rotationally fixed coupling to the sonic toothbrush drive has a channel running parallel to the base portion longitudinal axis that is designed/configured for a form-fit accommodation of a pin of the sonic toothbrush drive. The brush can therefore be attached to a pin of a sonic toothbrush drive using the adapter. Preferably, a latching element is provided so that the brush engages on (with) the sonic toothbrush drive. The pin is pivoted back and forth about its longitudinal axis and the brush as a whole carries out this longitudinal axis oscillating movement.

In a preferred embodiment, the base body comprises a load-bearing material having a Young's modulus of not more than 6000 MPa and not less than 2000 MPa. The bristle support is formed integrally with the base portion, in particular the adapter. Within the scope of the invention, the one-piece base body can also be formed from multiple elements (base portion, neck portion, head portion) that are connected, e.g., in a material-bonded manner. The main part of the brush can, for example, be a synthetic material injection-molded part. The bristle support, brush neck and base portion are then formed on this injection-molded part. If required, a local or total coating with a soft plastic sheath can be provided.

The present disclosure also relates to a set comprising a brush of the type according to any one of the embodiments described above or below and a sonic brush drive. The sonic brush drive may be provided in the form of a hand apparatus onto which the brush can be attached. The sonic brush drive is designed such that it oscillates the brush back and forth about the base portion longitudinal axis. The operating frequency should be in the range of 150-400 Hz, e.g., in the range of 150 Hz to 300 Hz.

In this range, the bristles are best able to carry out the desired two-dimensional “Figure 8” movement.

A particular embodiment of the brush and sonic brush drive set is characterized by the fact that the sonic brush drive generates a pivotal oscillation having an angular amplitude of max. 3° (with reference to a central position). It has been shown that only very small angular amplitudes are required. The amplitude in the “Figure 8” movement of the bristles will be larger, not least because the design of the brush and the value σₖ of the bristles operate in combination to achieve this.

The adapter of the base portion, for example, has a channel and the sonic brush drive has a pin which is insertable in a form-fit manner into the channel in order to create a non-rotating connection with respect to the base portion longitudinal axis, so that the brush as a whole can be driven in an oscillating manner about the base portion longitudinal axis (longitudinal axis of the pin).

Further advantageous embodiments and combinations of features of the invention result from the following detailed description and the entirety of the patent claims.

### BRIEF DESCRIPTION OF THE DRAWINGS

The drawings used to illustrate the embodiments show:

FIG. 1 a schematic representation of a plan view of a brush;

FIG. 2 a schematic representation of a side view of the brush;

FIG. 3 a schematic representation of a rear view of the brush;

FIG. 4 a schematic representation of a plan view of a sonic toothbrush comprising the brush;

FIGS. 5a, b a schematic side view and a plan view of a sonic toothbrush;

FIG. 6 a schematic representation of a side view of a sonic toothbrush with exactly one tuft;

FIG. 7 a schematic representation of the “Figure 8” movement according to the present disclosure;

FIG. 8 a schematic representation of the angular amplitude of the longitudinal axis oscillation;

FIG. 9 an embodiment with an oval brush head;

FIG. 10 an embodiment of a single-tufted brush with a bristle field on the back side; and

FIG. 11 an embodiment of a single-tufted brush with a bristle field on the front side.

In principle, identical parts are marked with the same reference symbols in the figures.

### DETAILED DESCRIPTION

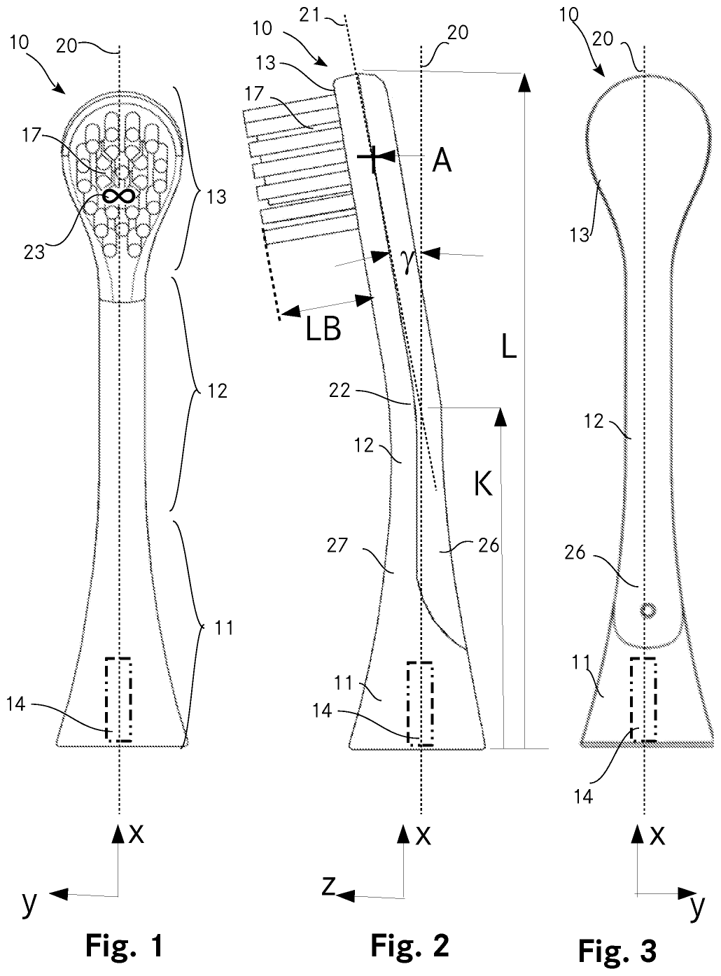

FIG. 1 shows a schematic representation of a plan view of a brush 10. The brush 10 comprises a frustoconical base portion 11, a rod-shaped neck portion 12 which adjoins the frustoconical base portion 11, and a plate-shaped head portion 13 which adjoins the neck portion 12. The three parts form the load-bearing base body of the brush.

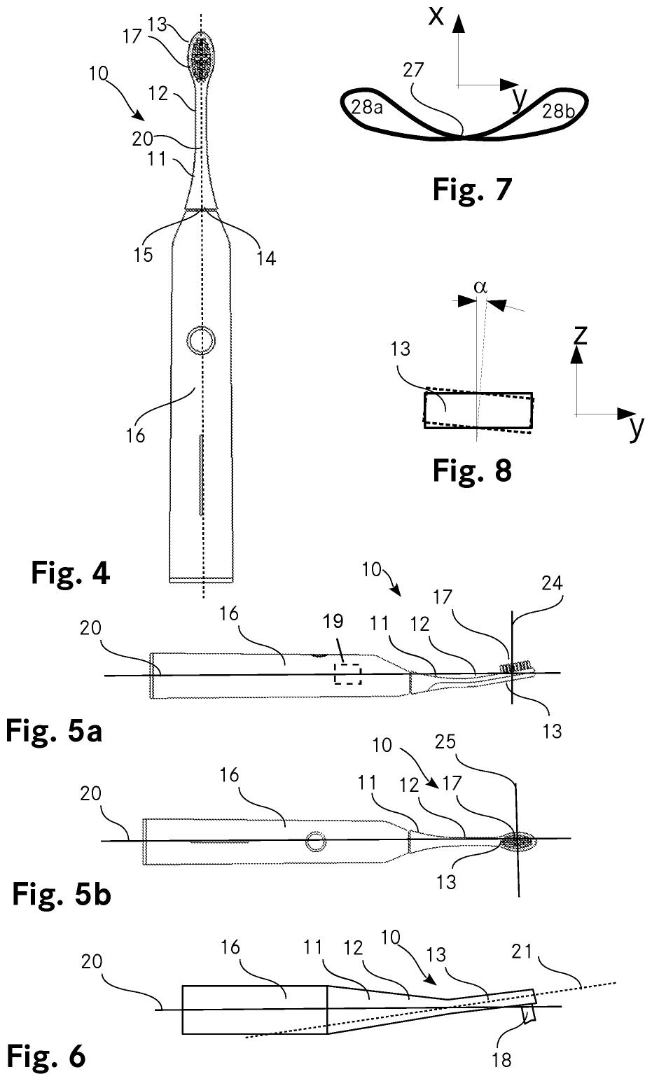

The frustoconical base portion 11 comprises a drive adapter. In the present embodiment, this is in essence formed by a channel-shaped receptacle 14, in which a pin of the hand apparatus of the sonic toothbrush is insertable and latchable (see FIG. 4 below). The brush 10 comprises a base portion longitudinal axis 20, which is aligned coaxially with respect to the holder 14 or coaxially with respect to the pin when the sonic toothbrush is in operation. This longitudinal axis defines the x-axis of the x-y-z coordinate system used herein. In other words, the drive adapter defines the geometric base portion longitudinal axis (x) of the brush.

In FIG. 1 the bristle field 17 of the head portion 13 is also evident, which in the present embodiment comprises multiple (e.g. 20-40) tufts, each with a plurality (e.g. 100-200) of bristles.

According to a preferred embodiment, the head portion 13 is teardrop-shaped in the front view. This means its shape widens successively-starting at the transition to the neck portion-almost to the upper end of the head portion, where it ends in a rounded end contour. With this shape, the center of gravity of the head portion 13 is (for a given length of the bristle field in the x-direction) closer to the terminal end of the brush. This can increase the eccentric effect at the specified operating frequency and thus also the “Figure 8” movement.

The main surface of the plate-shaped head portion 13 extends in essence transversely along the x-axis in the y-direction.

Furthermore, a “Figure 8” lying (extending) in the y-direction is shown on the bristle field 17 and denoted with the reference sign 23 in FIG. 1. The “Figure 8” illustrates the movement which is carried out during operation due to the selected material property (Young's modulus), the angle between the geometric base portion longitudinal axis 20 and the geometric head portion orientation axis (see further below) and the bend position in the plane.

In addition to the “Figure 8”, the head portion 13 of the brush 10 also carries out (undergoes) a small nodding movement-this movement is directed, in essence, at right angles to the “Figure 8”; i.e. the movement is in essence in (along) the z direction. In a preferred embodiment, the bristles are thus moved in three dimensions (x, y, z) during operation.

FIG. 2 shows a schematic representation of a side view of the brush 10. In addition to the geometric base portion longitudinal axis 20, the geometric head portion orientation axis 21 can also be seen in FIG. 2. In the illustration according to FIG. 1, the base portion longitudinal axis 20 and the head portion orientation axis 21 are one behind the other. The head portion orientation axis 21 is in essence the longitudinal axis of the head portion. The two axes intersect in (at) the geometric bend position 22. In the present embodiment, the geometric base portion longitudinal axis 20 and the geometric head portion orientation axis 21 enclose (form) an angle γ (gamma) of 10° as shown in FIG. 2. The geometric bend position 22 is spaced by a distance K from the end surface of the base portion 11; the distance K is 50% of the total length L of the brush 10. In this combination of the angle with respect to the bend position 22, a brush 10 is created with which a particularly effective and gum-friendly cleaning of the teeth is possible.

As can be seen by viewing FIGS. 1 and 2 together, in the present embodiment the head portion 13 is plate-shaped and the neck portion 12 is rod-shaped. In the projection of the base body onto the x-z plane, the head portion 13 and the neck portion 12 have the same transverse dimension (i.e. the same thickness). In the projection onto the x-y plane (front view according to FIG. 1), the head portion 13 is about three times as wide (y-direction) as the neck portion 12. The length (x-direction) of the head portion is about one third greater than the width (y-direction). For example, the neck portion 11 is one third as wide and 1.5 times as long as the head portion 13.

The neck portion 12 is tapered (narrowed) in relation to the head portion 13 and the base portion 11. In the present example, the neck portion 12 is less wide than the head portion 13 in at least one of the side views (viewed here in the z-direction according to FIG. 1).

In the present example, the base body of the brush 10 is composed, as the load-bearing material, of a glass fiber-reinforced polypropylene, namely Borealis GB311U having a Young's modulus of approximately 3500 MPA (Tensile Strength at yield =97 MPa; Elongation at Yield=2.8%; Young's modulus=Tensile Strength at Yield/Elongation at Yield).

The deflection is determined by the ratio of distance A to length L of the brush. The distance A corresponds to the distance from the front center of the head portion (which in this case corresponds to the center of the bristle field 17) to the base portion longitudinal axis 20 (see FIG. 2). In this example, the deflection is 14%.

The bristles are arranged here in multiple tufts and project perpendicularly away from the main surface of the plate-shaped head portion. In the present embodiment, they are perpendicular to the y-direction and run (extend) in the x-z plane. In the present embodiment, the bristles are attached to the front side of the head portion (or the front side 27 of the brush), that is, they point slightly downwards towards the adapter surface (y-z plane) of the base portion. The longitudinal axis of the bristles encloses (forms) an angle with the base portion longitudinal axis 20 that is less than 90°: namely 90° minus the bend angle γ.

FIG. 3 shows a schematic representation of a rear view of the brush 10 according to FIGS. 1 and 2. As can be seen from FIGS. 1-3, the base body has a different material on the rear side 26, which is soft and provides protection (protective coating, protective sheath) when the brush rear side comes into contact with the teeth. This material is non-load-bearing and can therefore have a Young's modulus outside the Young's modulus range of 2000-6000 MPa. The load-bearing material on the front side 27 is evident and it makes up an essential (substantial) part of the cross-section of the base body.

FIG. 4 shows a schematic representation of a plan view (z-direction) of a sonic toothbrush comprising the brush 10 and a hand apparatus 16 with a pin 15. The brush 10 is attached to the pin 15 so that the brush is detachable, rotationally fixed and axially fixed. The hand apparatus 16 rotates (pivots, oscillates) the pin 15 back and forth at a frequency of, for example, 180-270 Hz with an amplitude of, for example, 2° (relative to a rest (center) position) about the longitudinal axis of the pin 15 (which corresponds to the longitudinal axis of the hand apparatus 16). The brush 10 thus rotates (pivots, oscillates) back and forth about the base portion longitudinal axis 20 (x-axis).

FIG. 5a shows a schematic representation of a side view of a sonic toothbrush. The sonic toothbrush comprises a hand apparatus 16 and a brush 10. The drive of the hand apparatus 16 is designed as a piezoelectric drive 19, which generates an oscillation of the brush 10 about the x-axis 20 (longitudinal axis of the hand apparatus). The brush 10 thus carries out (undergoes) a rotational (pivotal) oscillation about the x-axis 20 relative to the handle (hand apparatus 16) during operation. Due to the above-described deflection of the head portion 13, an unbalance is created which enhances a movement component in the Y-direction 24 and/or in the Z-direction 25 (see below, FIG. 5b). This effect is controlled (determined) by the suitably angled bend in the brush neck and the suitably selected Young's modulus and can be adjusted by further geometric design features of the brush (such as bend angle position, deflection, mass distribution and other features according to the particular embodiments of the present disclosure).

FIG. 5b shows a schematic plan view of the personal care appliance (sonic toothbrush) according to FIG. 5a. The Z-direction 25 can be seen in this illustration. It runs, in essence, in the direction of the bristles. As can be seen from FIG. 5b, the hand apparatus is significantly larger than the brush. Only in this way can it generate a longitudinal axis oscillation (instead of an undefined or undirected vibration movement), as is the case with known sonic toothbrushes.

FIG. 6 shows an embodiment of the sonic toothbrush which comprises exactly one tuft 18. The tuft 18 is arranged on the rear side with respect to the head portion 13. The head portion 13 is thus inclined quasi rearward.

FIG. 7 shows a schematic representation of the “Figure 8” movement according to embodiments of the present disclosure. In the present case, the “Figure 8” movement has the shape of the number “8” flattened on one side, wherein an axis of symmetry (X axis) runs through (intersects) the center 27 of the number “8”. The two loops (eyes) 28a, 28b of the “8” extend primarily in the y-direction. However, the invention is not limited to exactly this form of “Figure 8” movement; the exact form of the movement ultimately depends on the parameters of the brush head and the oscillation generated by the motor of the hand apparatus.

FIG. 8 illustrates the amplitude of the longitudinal axis oscillation movement. The x-axis is perpendicular to the plane of the drawing. The plate-shaped head portion 13 (shown without bristles) pivots about the x-axis by the angle α (alpha). (The bristles extend upwards in the z-direction in FIG. 8.) The main component of the pivot movement (and thus the bristle wiping movement) is in the y-direction. The angle α (alpha) between the rest position (drive switched off) and the maximum deflection from the rest position is preferably a maximum of 3°, preferably 2°. The deflection from “maximum left” to “maximum right” is therefore 6° or 4°.

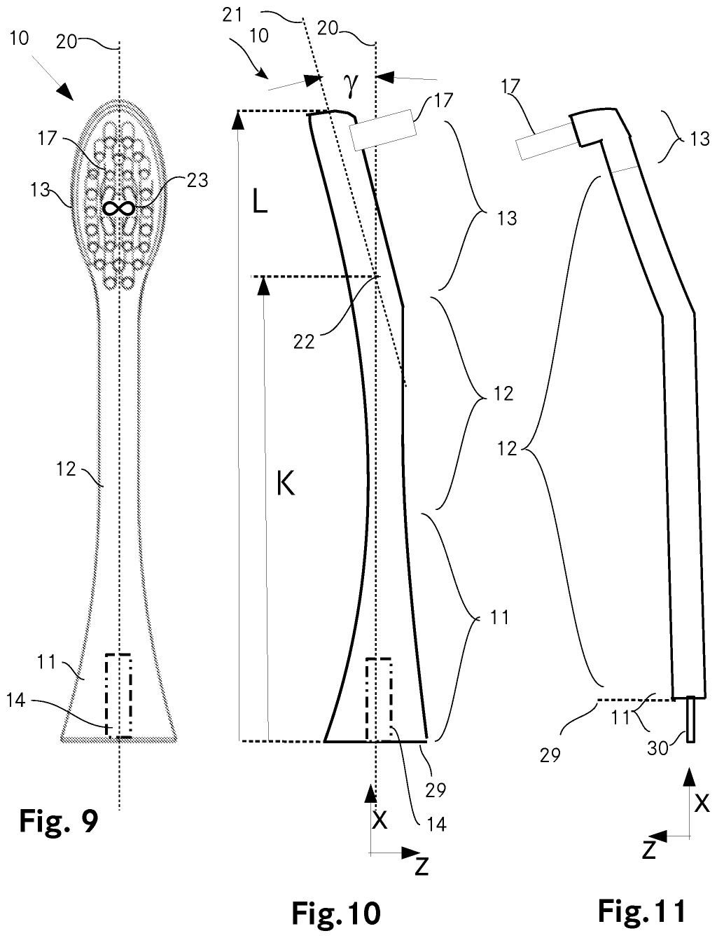

FIG. 9 shows a brush 10 with a plate-shaped oval head portion 13. The longitudinal axis of the oval shape runs (extends) in essence in the x-direction and the transverse axis runs (extends) in the y-direction. The center of the head portion 13 is further away from the upper (terminal) end of the brush 10 than in the drop-shaped head portion shown in FIG. 1.

FIG. 10 shows a brush with a bend angle γ (gamma) of 14° and a distance K from the geometric bend position 22 to the end surface 29 of the base portion 11 of 75% with reference to the length L of the brush 10.

The base portion 11 tapers from the end surface 29 to the transition into the neck portion 12. The base portion 11 can be, for example, frustoconical or truncated pyramid-shaped, wherein it has, for example, a concave profile in longitudinal section. Thus, the center of gravity of the base portion 11 is closer to the end surface 29 than in a comparable base portion having straight profile lines.

In the embodiment shown in FIG. 10, the neck portion 12 occupies approximately half the length (L) of the brush 10. As FIG. 10 illustrates, the neck portion 12 does not necessarily have to have a constant cross-section over its entire length. It can certainly have a varying contour.

The head portion 13 is formed by the extension of the neck portion 12. In the present example, the head portion 13 has in essence the same transverse dimensions (viewed in a section perpendicular to the head portion orientation axis 21) as the neck portion 12. The bristle field 17 is positioned on the side of the head portion 13. The bristles therefore protrude perpendicular with respect to the head portion orientation axis 21.

FIG. 11 shows an embodiment in which the base portion 11 is in essence formed by a pin 30 that serves as a drive adapter. The neck portion 12 is rod-shaped and occupies, for example, 90% of the length of the brush. The head portion 13 is the part in which the bristle field 17, here in the form of a single tuft, is anchored. The pin 30 is inserted into the hand apparatus (16) in the x-direction for rotationally fixed coupling to a sonic tooth brush drive (19) with longitudinal axis oscillation, wherein the drive adapter defines the geometric base portion longitudinal axis (x) of the brush.

A brush according to FIG. 11, for example, is made of a material having a Young's modulus of approx. 4600 MPa. LNP ULTEM® EXCP0096 Polyetherimide, 30% Carbon Fiber Reinforcement, 10% PTFE Lubricant (Tensile Strength at Yield=163 MPa, Elongation at Yield=3.5%, Tensile Strength/Elongation=4650 MPa) is given as an example of such a material.

In further embodiments not shown, instead of the bristle field 17 the brush 10 comprises an interdental brush for cleaning interdental spaces.

Additional embodiments of the present teachings will now be explained with reference to specific examples of suitable parameters. Here, the length LB of the bristles is measured from their exit from the front of the head portion to their tip as shown in FIG. 2. In Examples 1 to 6, the bristles are arranged in a plurality of slightly spaced-apart tufts.

Example 1: The brush has a bend angle γ=14° and a deflection A with reference to the length L of the brush of 10%. The value σₖ of the bristles is around 9.7 MPa. All bristles are made of the same material and have the same geometric dimensions. The Young's modulus of the bristles is 2000 MPa. The length LB of the bristles is 6 mm. The bristles are circular in cross-section and have a diameter of 0.15 mm. This brush is particularly suitable for longitudinal axis oscillation at a frequency of no more than 200 Hz. The brush can be designed, for example, as shown in FIG. 10 or 11.

Example 2: The brush has a bend angle γ=12° and a deflection A with reference to the length L of the brush of 11%. The value σₖ of the bristles is around 4.5 MPa. All bristles are made of the same material and have the same geometric dimensions. The Young's modulus of the bristles is 4000 MPa. The length LB of the bristles is 10 mm. The bristles are circular in cross-section and have a diameter of 0.12 mm. This brush is particularly suitable for longitudinal axis oscillation at a frequency of 150-300 Hz.

Example 3: The brush has a bend angle γ=10° and a deflection A with reference to the length L of the brush of 7%. The value σₖ of the bristles is around 2.4 MPa. All bristles are made of the same material and have the same geometric dimensions. The Young's modulus of the bristles is 4500 MPa. The length LB of the bristles is 12 mm. The bristles are circular in cross-section and have a diameter of 0.10 mm. This brush is particularly suitable for longitudinal axis oscillation at a frequency of 150-300 Hz.

Example 4: The brush has a bend angle γ=8° and a deflection A with reference to the length LB of the bristles of 70%. The value σₖ of the bristles is around 1.5 MPa. All bristles are made of the same material and have the same geometric dimensions. The Young's modulus of the bristles is 3500 MPa. The length LB of the bristles is 12 mm. The bristles are circular in cross-section and have a diameter of 0.09 mm. This brush is particularly suitable for longitudinal axis oscillation at a frequency of up to 400 Hz.

Examples 2 to 4 can be designed, for example, like the brush shown in FIGS. 1 to 3.

Example 5: The brush has a bend angle γ=10° and a deflection A with reference to the length L of the brush of 10%. The value σₖ of the bristles is around 0.52 MPa. All bristles are made of the same material and have the same geometric dimensions. The Young's modulus of the bristles is 1500 MPa. The length LB of the bristles is 12 mm. The bristles are circular in cross-section and have a diameter of 0.08 mm. This brush is particularly suitable for longitudinal axis oscillation at a frequency of 150-300 Hz.

Example 6: The brush has a bend angle γ=11° and a deflection A with reference to the length L of the brush of 8%. The value σₖ of the bristles is around 2.3 MPa. All bristles are made of the same material and have the same geometric dimensions. The Young's modulus of the bristles is 3000 MPa. The length LB of the bristles is 10 mm. The bristles are circular in cross-section and have a diameter of 0.10 mm. This brush is particularly suitable for longitudinal axis oscillation at a frequency of 150-300 Hz.

Example 7: The brush has a bend angle γ=9° and a deflection A with reference to the length L of the brush of 7%. The brush has two different types of bristles. In an edge area, which is essential for cleaning at the transition between tooth and gum, the bristles have a value σₖ according to Example 2. In an inner area enclosed by the edge area, the Young's modulus is 4000 MPa, the length of the bristles is 9 mm. The bristles are circular in cross-section and have a diameter of 0.12 mm in the entire area. The value σₖ in the inner area is 5.5 MPa. This brush is particularly suitable for longitudinal axis oscillation at a frequency of 150-300 Hz.

Example 8: The brush has a bend angle γ=16° and a deflection A with reference to the length L of the brush of 17%. The brush has two different types of bristles. The majority of the bristles, which are essential for cleaning at the transition between the tooth and gum, have a value σₖof 2.6 MPa. The Young's modulus of the bristles mentioned is 4500 MPa, the length LB of the bristles is 7 mm. The bristles are circular in cross-section and have a diameter of 0.06 mm throughout. This brush is particularly suitable for longitudinal axis oscillation at a frequency of 150-300 Hz.

Examples 5 to 8 can be designed, for example, as shown in each of the brushes of FIGS. 1 to 3 and 9 to 11.

The bristles need not be circular in cross-section. They can also be slightly oval or non-circular, for example in that the transverse dimension in one direction is 20% larger than the transverse dimension in the direction perpendicular thereto.

In summary, it is to be ascertained that, according to the present teachings, a brush for a sonic toothbrush drive is created which leads to a particularly advantageous movement of the head portion for effective and efficient cleaning of the teeth.

1. A brush for a sonic toothbrush with longitudinal axis oscillation, having:
an elongate base body having a base portion, a neck portion and a head portion,
an adapter for rotationally fixed coupling to a sonic toothbrush drive of the sonic toothbrush in order to pivotally oscillate the brush about a base portion longitudinal axis, the adapter being provided on the base portion,
a bristle support provided on the head portion, and
a plurality of bristles anchored in the head portion,
wherein:
the neck portion is disposed between the base portion and the head portion,
the head portion has a head portion orientation axis,
the base body includes a bent portion having a bend angle γ formed by the base portion longitudinal axis and the head portion orientation axis in the range from 7° to 17°,
the bristle support has a deflection in the range of 5%-20% with reference to a length (L) of the elongated base body,
the bristles extend at least substantially perpendicular to the head portion orientation axis,
at least a portion of the bristles has a value σₖ in the range from 0.1 to 10 MPa as calculated according to the following equation:
$${σ}_{k} = \frac{{π}^{3}}{{L}^{2}} \cdot E \cdot {r}^{2}$$
π=number Pi(=3.14),
E=Young's modulus of the bristles,
r=half the diameter of the bristle, and
L=length of the bristle.

2. The brush according to claim 1, wherein the value σₖ is at most 4 MPa.

3. The brush according to claim 1, wherein the value σₖ is at least 1 MPa.

4. The brush according to claim 1, wherein the value σₖ is in the range from 1 MPa to 4 MPa.

5. The brush according to claim 1, wherein the bristles have a Young's modulus in the range from 1000 MPa to 3500 MPa.

6. The brush according to claim 1, wherein the bristles have a Young's modulus of not more than 2000 MPa.

7. The brush according to claim 1, wherein the bristles have a Young's modulus in the range from 2500 MPa to 3500 MPa.

8. The brush according to claim 1, wherein the bristles have an average length in the range up to a maximum of 10 mm.

9. The brush according to claim 1, wherein the deflection is in the range from 5% to 15%.

10. The brush according to claim 1, wherein the bristles have a diameter of not more than 0.12 mm.

11. The brush according to claim 1, wherein the bend angle γ is in the range from 12° to 17°.

12. The brush according to claim 1, wherein the bend angle γ is in the range from 7° to 12°.

13. The brush according to claim 1, wherein the bristles are arranged in the form of tufts which are spaced apart from one another.

14. The brush according to claim 1, wherein at least two different bristle lengths are provided.

15. The brush according to claim 1, wherein the adapter for rotationally fixed coupling to the sonic toothbrush drive has a channel extending parallel to the base portion longitudinal axis configured to receive in a form-fit manner a pin of the sonic toothbrush drive.

16. The brush according to claim 1, wherein the elongate base body comprises a load-bearing material having a Young's modulus of not more than 6000 MPa and not less than 2000 MPa.

17. A sonic toothbrush comprising:
the brush according to claim 1, and
a hand apparatus including the sonic toothbrush drive,
wherein the brush is detachably attachable to the sonic toothbrush drive,
the sonic toothbrush drive of the hand apparatus is configured to drive the brush in a pivotal oscillating manner about the base portion longitudinal axis, and
the sonic toothbrush drive has an operating frequency in the range from 150 to 400 Hz.

18. The sonic toothbrush Set according to claim 17, wherein the sonic toothbrush drive is configured to generate a pivotal oscillation having an angular amplitude of max. 3°.

19. The sonic toothbrush according to claim 18, wherein the adapter of the elongate base portion has a channel and the sonic toothbrush drive includes a pin that is insertable in a form-fit manner into the channel in order to create a detachably fixed connection with respect to the base portion longitudinal axis, so that the brush as a whole is drivable in the pivotal oscillating manner about the base portion longitudinal axis.

20. The brush according to claim 2, wherein:
the Young's modulus of the bristles is in the range from 1000 MPa to 3500 MPa,
the deflection is in the range from 7% to 13%,
the bristles have a diameter of 0.08-0.12 mm,
the angle γ is in the range from 7° to 12°, and
the bristles have an average length of at least 5 mm.
